(19) United States
(12) Patent Application Publication
(10) Pub. No.: US 2003/0038077 A1
(43) Pub. Date: Feb. 27, 2003

(54) Manifold adapted for replaceable fluid filter cartridge

(76) Inventors: Young Sik Nam, Suwon City (KR); Soon Tae Kim, Uiwang City (KR)

Correspondence Address: CHA & REITER, 411 Hackensack Ave, 9th Floor, Hackensack, NJ, 07601, US

(21) Appl. No.: 10/191,644

(22) Filed: Jul. 9, 2002

(30) Foreign Application Priority Data
Aug. 27, 2001 (KR) 2001-51895

(51) Int. Cl. B01D 35/157

(52) U.S. Cl. 210/443; 210/418

(57) ABSTRACT

Disclosed is a manifold for supplying fluid to a filter cartridge and discharging treated fluid to a desired place. The manifold possesses inlet and outlet conduits and a housing. A first valve assembly is provided in the inlet conduit to control fluid flow upon changing the filter cartridge and has a stem valve. When the filter cartridge is coupled to the manifold, as the stem valve comes into contact with one flange and pressed thereby, fluid can flow through the inlet conduit into the filter cartridge. The housing is defined with a flow bore through which filtered water can flow and a reservoir in which the filtered water flowing through the flow bore is stored. Each outlet conduit is provided with a port, and a second valve assembly is provided to the port. A pipe jointing assembly is provided to the port to allow pipes to be easily jointed and disjointed. Flow control means is provided in the reservoir of the housing and includes a flow control unit. The flow control unit has a sinking surface, an opposite flat surface and a flow control hole defined through a center portion thereof. When fluid is discharged from the reservoir toward the outlet conduit, as a fluid pressure is applied to the flow control unit, the sinking surface and the opposite flat surface are displaced such that they are reversed in their surface contours.

### BACKGROUND OF THE INVENTION

1. Field of the Invention

The present invention relates to a manifold to which a replaceable filter cartridge constituting a part of a water purification system is coupled, and more particularly, the present invention relates to a manifold in which inlet and outlet passages are defined in the shape of conduits and fluid-flow controlling devices are provided in the conduits, thereby preventing leakage from water supply lines upon changing the filter cartridge.

2. Description of the Related Art

With the development of living appliances used at home or in offices, etc., demand for water purification and filtration systems to be used in a state wherein they are coupled to the appliances has been gradually increased. A water purification or filtration device serving as one main component element of such water purification and filtration systems typically adopts a replaceable filter cartridge. In this regard, it is the norm that filter cartridges are formed each to have a single or unitary port having multiple flow channels therein, and this type of filter cartridges are disclosed in U.S. Pat. Nos. 4,915,831, 5,336,406 and 5,354,464.

A connecting device or manifold serving as another main component element of the water purification and filtration system functions to receive and transfer fluid such as water to the filter cartridge and direct filtered fluid to desired places inside the appliance. Each of the connecting devices or manifolds such as disclosed in U.S. Pat. Nos. 4,915,831, 5,336,406 and 5,753,107 is provided with a single inlet port and a single outlet port, and the connecting device or manifold such as disclosed in U.S. Pat. No. 5,354,464 is provided with multiple ports.

Meanwhile, it is necessary to periodically change the filter cartridge used in the water purification and filtration system. In this connection, a problem is caused in that leakage may occur in water supply lines upon changing the filter cartridge. In order to prevent leakage from water supply lines upon changing a filter cartridge, as described in U.S. Pat. No. 5,753,107, a flow control valving must be provided to a manifold or the filter cartridge. As the case may be, the filter cartridge can be inadvertently decoupled from a connecting device to cause water leakage. Solutions to cope with this problem are disclosed in U.S. Pat. Nos. 4,915,831 and 5,336,406.

Due to the fact that the conventional water purification and filtration system adopts a configuration that, by rotating the filter cartridge in one direction relative to the connecting device, they are coupled to each other, and by rotating the filter cartridge in the other direction, they are decoupled from each other, coupling and decoupling of the filter cartridge and connecting device to and from each other can be easily effected. In order to ensure that water is supplied from a water supply source such as waterworks or a water tank to the connecting device and flows through the filter cartridge, and filtered water is directed again through the connecting device to a desired place (for example, an ice making section of a refrigerator), a conduit such as a pipe should be provided to join the connecting device and the water supply source with each other. In the conventional art, disadvantages are caused in that, since a screwed type pipe fitting structure is adopted in which pipes are threadedly joined to ports of the connecting device, it is cumbersome and time-consuming to connect, using pipes, an inlet port of the connecting device with the water supply source and an outlet port of the connecting device with the desired place. Because the connecting device and the pipes are joined with each other in this way, when it is necessary to change the pipes due to aging, damage, etc., laborious work must be carried out.

Moreover, in the conventional connecting device, it is considered as an essential point to define inlet and outlet passages for receiving water from the water supply source, transferring water to the filter cartridge and directing the filtered water to the desired place. Therefore, it is difficult to install on the manifold itself a fluid-flow shutoff valve for preventing water leakage upon changing the filter cartridge. Also, even in the case that the fluid-flow shutoff valve is installed on the manifold, the connecting device and the filter cartridge must be designed in such a way as to structurally interact with each other.

### SUMMARY OF THE INVENTION

Accordingly, the present invention has been made in an effort to solve the problems occurring in the related art, and an object of the present invention is to provide a pipe or tube connecting structure in which inlet and outlet passages of a manifold are defined by conduits having the shape of pipes or tubes, and the manifold and external pipes are easily fitted into and released from each other.

Another object of the present invention is to provide a manifold in which fluid is allowed to be introduced into and discharged from a housing of the manifold through inlet and outlet passages of the manifold, having the shape of conduits, in a manner such that valve devices can be easily installed on the conduits extending outward from the housing of the manifold.

Another object of the present invention is to provide a manifold in which inlet and outlet passages extending outward from a housing of the manifold are designed to have separate ports or chambers to be connected with valve devices, thereby performing a function of a multi-port connecting device.

Another object of the present invention is to provide a manifold in which a chamber or a reservoir is formed in a housing of the manifold to store a predetermined amount of fluid, thereby managing a fluid amount variation resulting from a fluid pressure change.

Still another object of the present invention is to provide a flow control unit which can control a flow rate of fluid supplied from a reservoir defined in a housing of a manifold to an outlet passage, in response to a fluid amount variation in the reservoir.

Yet still another object of the present invention is to provide a manifold which can prevent leakage out of fluid supply lines upon changing a filter cartridge, and a filter cartridge which is coupled to the manifold.

The above-described objects and other advantages are achieved by a manifold according to the present invention, which constitutes a water purification and filtration system and possesses inlet and outlet passages having the shape of conduits and a cylindrical housing. The inlet and outlet conduits are formed to extend outward from the housing, and preferably integrated with the housing.

A first valve assembly is provided in a tubular passage of the inlet conduit to control fluid flow upon changing a filter cartridge. The first valve assembly essentially comprises a stem valve, in a manner such that, when the filter cartridge having two-staged flanges is coupled to the manifold, as the stem valve comes into contact with one flange and is pressed thereby, fluid can flow through the inlet conduit into the filter cartridge. On the contrary, when the filter cartridge is decoupled from the manifold, as force for supporting the stem valve is vanished, fluid flow is shut off. Of course, it is to be readily understood that the first valve assembly may comprise an electromagnetic valve for controlling fluid flow in response to an electric signal and may be designed to control fluid flow by a separate signaling scheme independently of an operation of changing a filter cartridge.

The housing is defined with a flow bore through which water filtered in the filter cartridge can flow and a reservoir in which the filtered water flowing through the flow bore is stored. Accordingly, the reservoir can appropriately manage a fluid amount variation by storing a predetermined amount of fluid.

Each outlet conduit is provided with a port or a chamber, and a second valve assembly capable of controlling fluid flow is provided to the port or chamber. In addition to the second valve assembly, a pipe jointing assembly is provided to the port or chamber to allow pipes to be easily jointed and disjointed, whereby a pipe connecting work can be conveniently implemented.

Further, flow control means is provided in the reservoir of the housing and includes a flow control unit. The flow control unit is made of a soft material and has a sinking surface, an opposite flat surface and a flow control hole defined through a center portion thereof. The flow control unit is located in a depression defined on an inner end surface of the housing, which inner end surface faces the outlet conduit, and is supported by a wheel-shaped retainer.

As a consequence, when fluid is discharged from the reservoir toward the outlet conduit, the fluid flows through the flow control hole of the flow control unit. At this time, because a fluid pressure is applied to the flow control unit, the sinking surface and the opposite flat surface are displaced in a manner such that they are reversed in their surface contours. Due to the displacement, a diameter of one end of the flow control hole, which one end faces the outlet conduit, is slightly increased, and a diameter of the other end of the flow control hole, which other end is farthest from the outlet conduit, is slightly decreased, whereby fluid flow control can be executed in a precise manner.

### BRIEF DESCRIPTION OF THE DRAWINGS

The above objects, and other features and advantages of the present invention will become more apparent after a reading of the following detailed description when taken in conjunction with the drawings, in which:

FIG. 1 is a perspective view illustrating a manifold according to the present invention, a filter cartridge coupled to the manifold, and a structure for attaching the manifold to an electric appliance;

FIG. 2 is a side view illustrating an in-use status of the manifold according to the present invention, with the filter cartridge coupled to the manifold which is attached to the electric appliance;

FIG. 3 is a cross-sectional view taken along the line A-A of FIG. 2;

FIG. 4 is a cross-sectional view taken along the line B-B of FIG. 3;

FIG. 5 is a cross-sectional view taken along the line C-C of FIG. 3;

FIG. 6A is a cross-sectional view taken along the line D-D of FIG. 3;

FIG. 6B is a partially-sectioned enlarged perspective view illustrating a structure of a valve body part of FIG. 6A;

FIG. 6C is an enlarged cross-sectional view illustrating flow control means of FIG. 6A;

FIG. 7 is a cross-sectional view taken along the line E-E of FIG. 3; and

FIGS. 8A and 8B are cross-sectional views illustrating a structure for connecting pipes at each joint region of the manifold according to the present invention.

### DETAILED DESCRIPTION OF PREFERRED EMBODIMENTS

Reference will now be made in greater detail to a preferred embodiment of the invention, an example of which is illustrated in the accompanying drawings. Wherever possible, the same reference numerals will be used throughout the drawings and the description to refer to the same or like parts.

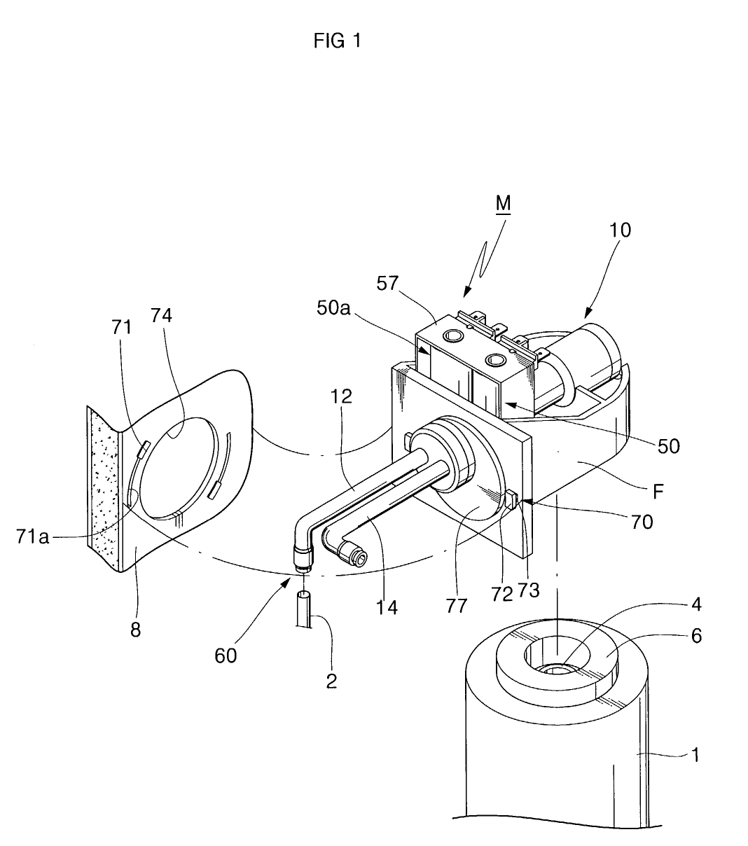

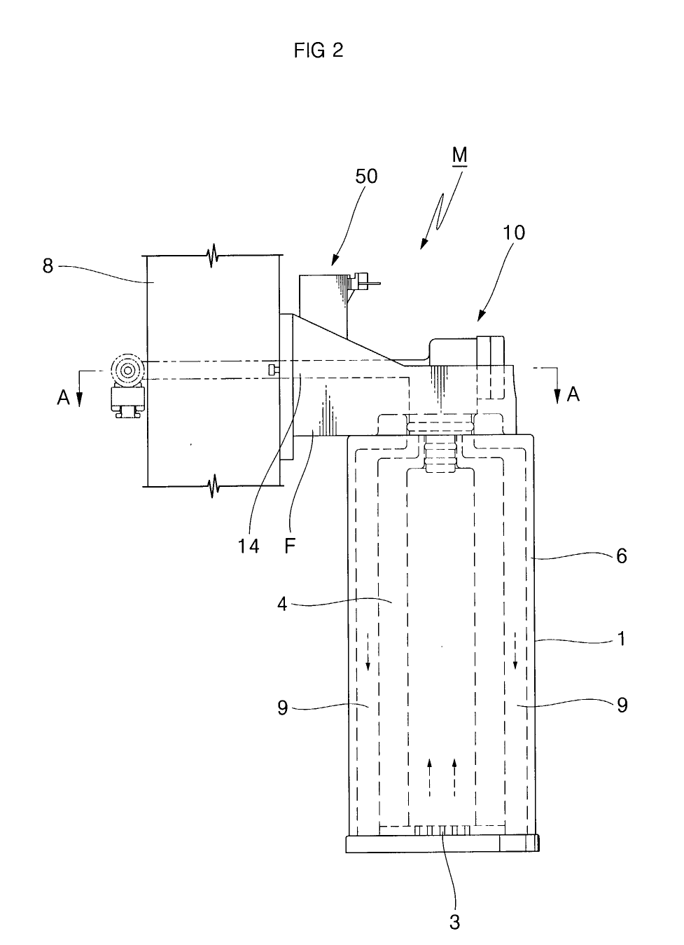

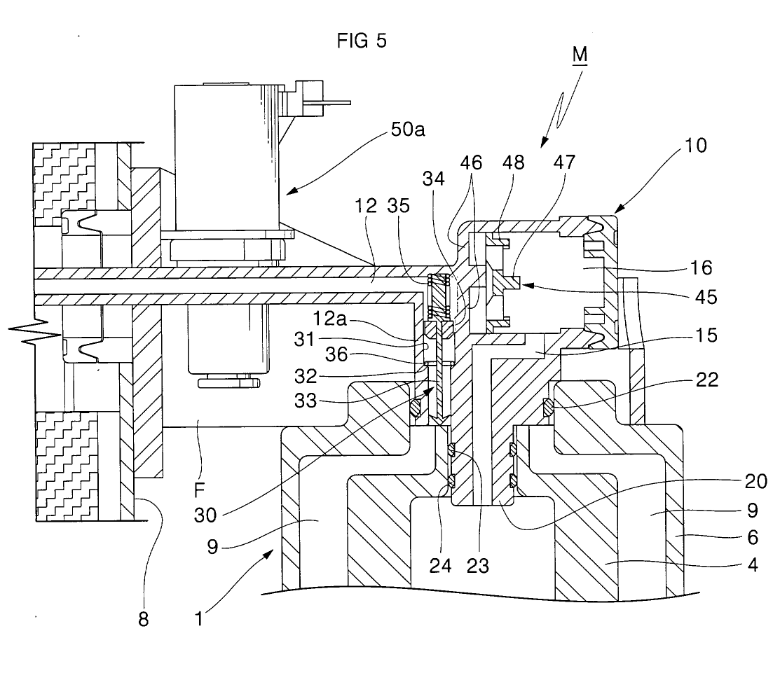

Referring to FIGS. 1, 2 and 5, a manifold M according to the present invention includes a cylindrical housing 10, an inlet conduit 12, and a pair of outlet conduits 14 and 14a. The inlet conduit 12 is connected to a water supply source by a water supply pipe 2 such as waterworks. If water is supplied through the inlet conduit 12, as shown in FIG. 2 by arrows, the water flows through a flow space 9 which is defined between inner and outer cylindrical canisters 4 and 6 of a filter cartridge 1 serving as a fluid treatment device, and, after flowing through a plurality of holes 3 defined adjacent to a bottom of the filter cartridge 1, passes through a filtering substance (not shown) which is disposed in the inner cylindrical canister 4. Then, the fluid is introduced into the housing 10 through a flow bore 15 and thereafter, discharged out of the housing 10 through the outlet conduits 14 and 14a.

Detailed structures of the filter cartridge having two-staged flanges and of the first valve assembly cooperating with the filter cartridge to prevent water leakage are disclosed in U.S. Pat. No. 5,753,107 which is incorporated herein by reference.

Second valve assemblies 50 and 50a are installed in the pair of outlet conduits 14 and 14a, respectively, to control fluid flow through the outlet conduits 14 and 14a. The inlet conduit 12 of the manifold M is connected with the water supply pipe 2 by a pipe jointing assembly 60, as will be described later in detail.

The manifold M according to the present invention is used in a state wherein it is attached to a wall 8 of an appliance such as a refrigerator. The manifold M can be easily attached to and detached from the wall 8 by virtue of a fixing unit 70. The fixing unit 70 includes a pair of heads 72 which are provided on a frame F of the manifold M, a pair of shank portions 73 for respectively supporting the heads 72, and a circular plate 77. The wall 8 of the appliance is defined with a pair of curved slits 71a which are opposite to each other and have enlarged slit portions 71, and an opening 74 for receiving the circular plate 77. The pair of slits 71a generally define a circular figure.

When fixing the manifold M to the appliance, by fitting the heads 72 into the enlarged slit portions 71 and then rotating the manifold M in a counterclockwise direction, the manifold M is attached to the wall 8 by the medium of the shank portions 73 inserted into the curved slits 71a. At this time, as the circular plate 77 is fitted into the opening 74, a fixed state of the manifold M can be stably maintained. An adiabatic material is interposed between the inlet conduit 12 and the outlet conduits 14 and 14a.

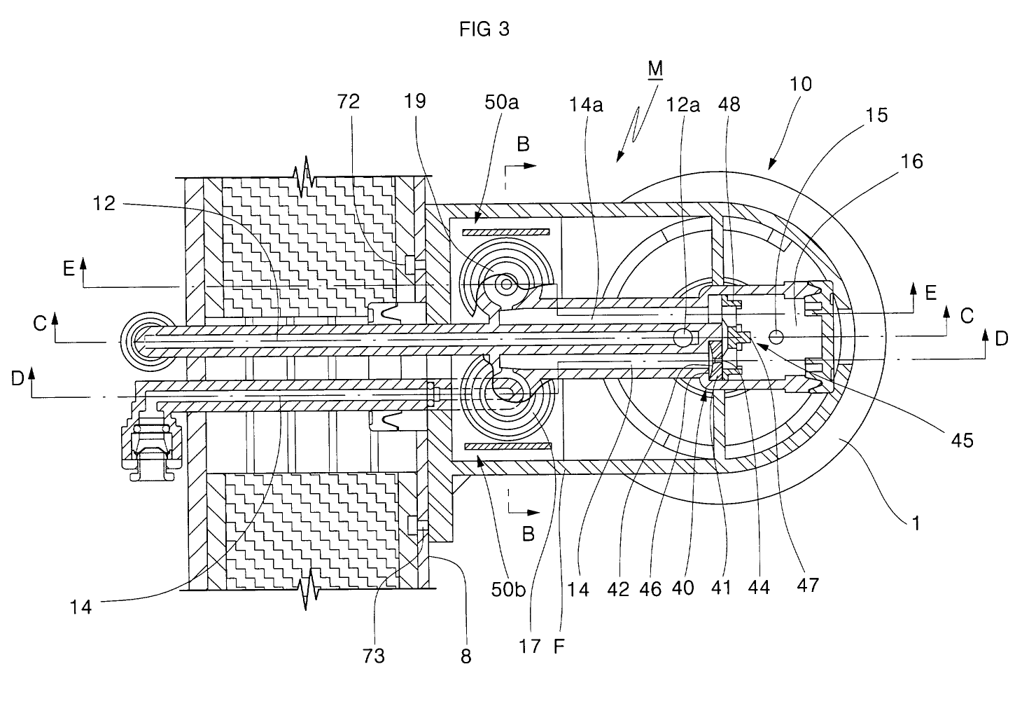

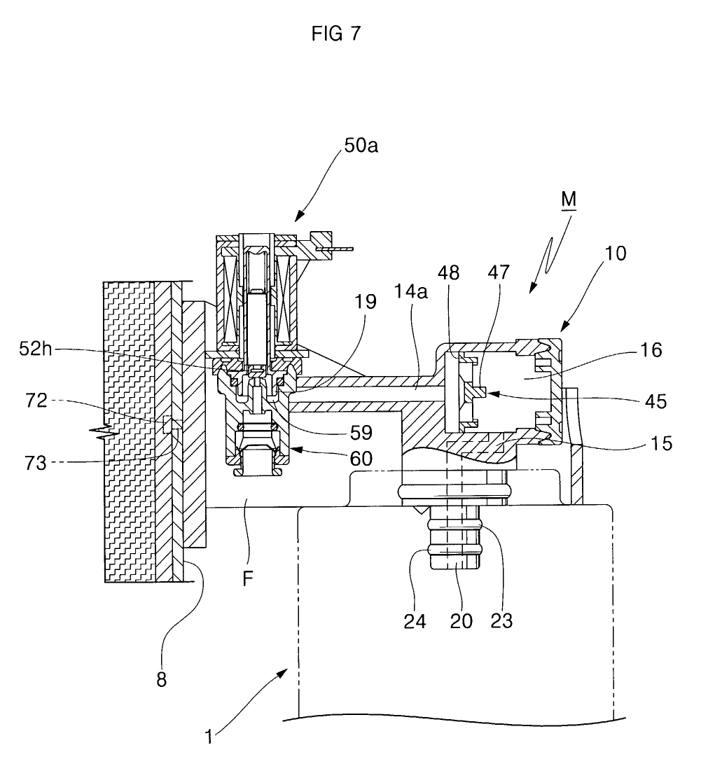

Referring to FIGS. 3 through 7, it is to be readily understood that the manifold M has the housing 10 and the inlet conduit 12 which is fixed to a side wall of the housing 10 and formed to extend by a substantial length. The inlet conduit 12 has a portion 12a which is substantially perpendicularly downwardly bent in relation to an entrance of the inlet conduit 12. The first valve assembly 30 is provided to the bent portion 12a of the inlet conduit 12. A tubular passage 31 of the bent portion 12a is formed with a tapered surface 32. A valve head 34 is formed at an upper end of a valve stem 33, and an O-ring 36 is provided on the tapered surface 32. A spring 35 is placed between an inner upper surface of the inlet conduit 12 and the valve head 34.

A space is defined in the tubular passage 31 of the bent portion 12a between the tapered surface 32 and the valve head 34, to create a fluid flow channel. Below the tapered surface 32 of the bent portion 12a, the tubular passage 31 is formed to have an inner diameter which corresponds to an outer diameter of the valve head 34.

The manifold M is formed, on a lower surface thereof, with a fitting portion 20 which projects downward. A reservoir 16 is defined in an upper part of the housing 10. Due to the fact that the flow bore 15 is defined through the fitting portion 20, the reservoir 16 and the filter cartridge 1 are communicated with each other.

In the case of coupling the filter cartridge 1 designed to have a double-staged flange structure to the manifold M according to the present invention, a lower part of the housing 10, including the bent portion 12a of the inlet conduit 12, is fitted into the outer cylindrical canister 6 of the filter cartridge 1, and the fitting portion 20 of the housing 10 is fitted into the inner cylindrical canister 4. When the manifold M and the filter cartridge 1 are coupled with each other, an upper end surface of the inner cylindrical canister 4 of the filter cartridge 1 presses upward the valve stem 33 of the first valve assembly 30 and biases upward the first valve assembly 30 against elastic force of the spring 35. Consequently, as the valve head 34 is separated upward from the tapered surface 32 in the tubular passage 31 defined in the bent portion 12a of the inlet conduit 12, fluid flows through the inlet conduit 12 and the fluid flow channel defined between the valve head 34 and the tubular passage 31 into the flow space 9 defined in the filter cartridge 1. Then, the fluid is filtered while passing through a filtering substance (not shown) which is disposed in the inner cylindrical canister 4 of the filter cartridge 1. O-rings 22, 23 and 24 are fitted around the lower part and fitting portion 20 of the housing 10 to prevent water leakage.

Filtered fluid, for example, water is introduced from the inner cylindrical canister 4 through the flow bore 15 of the fitting portion 20 into the reservoir 16 of the housing 10 so that a predetermined amount of water can be stored in the reservoir 16.

On the other hand, in the case of decoupling the filter cartridge 1 from the manifold M, as the spring 35 presses downward the valve head 34, the first valve assembly 30 is moved downward. Consequently, as the valve head 34 is seated on the O-ring 36 which is provided on the tapered surface 32 to serve as a valve seat, the tubular passage 31 defined in the bent portion 12a of the inlet conduit 12 is closed. In this way, upon changing the filter cartridge 1, by cooperation between the first valve assembly 30 and the filter cartridge 1, water leakage is prevented. As described above, detailed structures of the filter cartridge 1 having two-staged flanges and of the first valve assembly 30 cooperating with the filter cartridge 1 are disclosed in U.S. Pat. No. 5,753,107 which is incorporated herein by reference.

In succession, referring to FIGS. 3 through 7, fluid flows from the reservoir 16 into the pair of outlet conduits 14 and 14a which extends substantially parallel to the inlet conduit 12, to then be finally supplied to destination devices. For example, water flowing through the first outlet conduit 14 can be supplied to an ice making section of a refrigerator, and water flowing through the second outlet conduit 14a can be supplied as a cooling water. A person skilled in the art will readily recognize that the number of outlet conduits may vary depending upon a use. Also, it can be envisaged that the outlet conduits 14 and 14a extend in a direction opposite to the inlet conduit 12.

A pair of ports 17 and 19 are respectively formed in the course of the outlet conduits 14 and 14a, and a pair of second valve assemblies 50 and 50a are respectively installed on the ports 17 and 19.

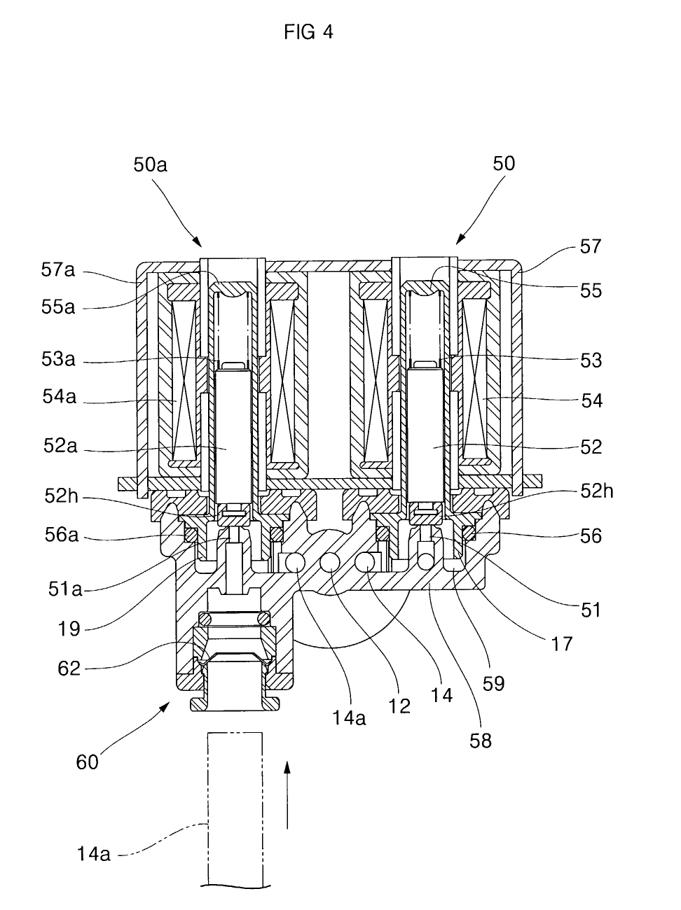

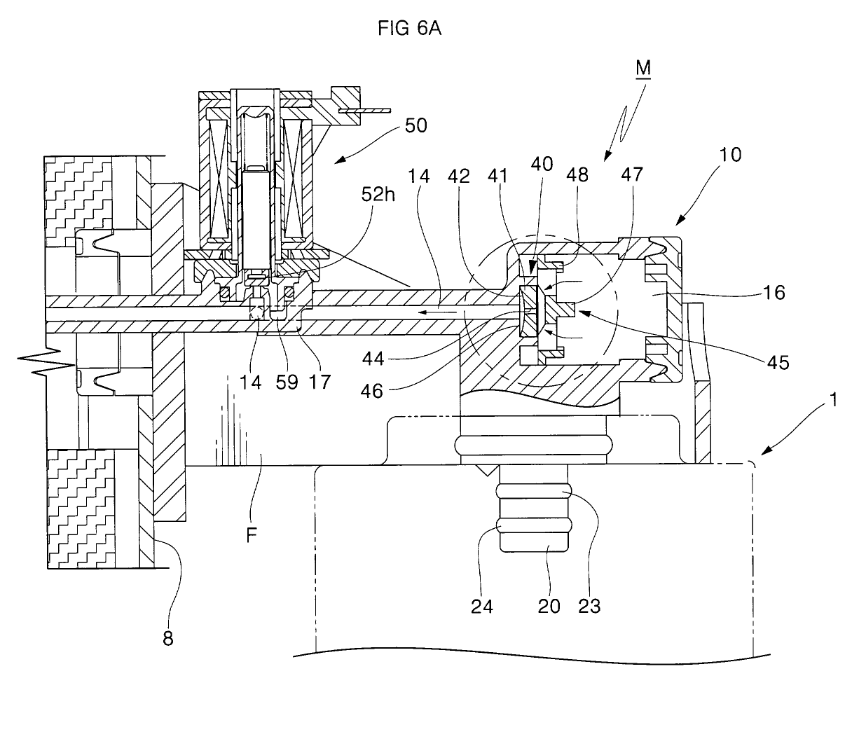

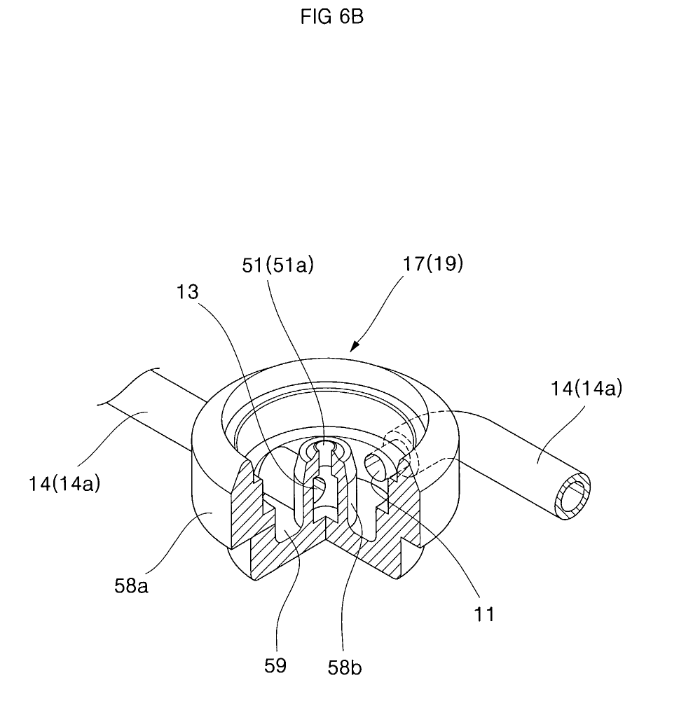

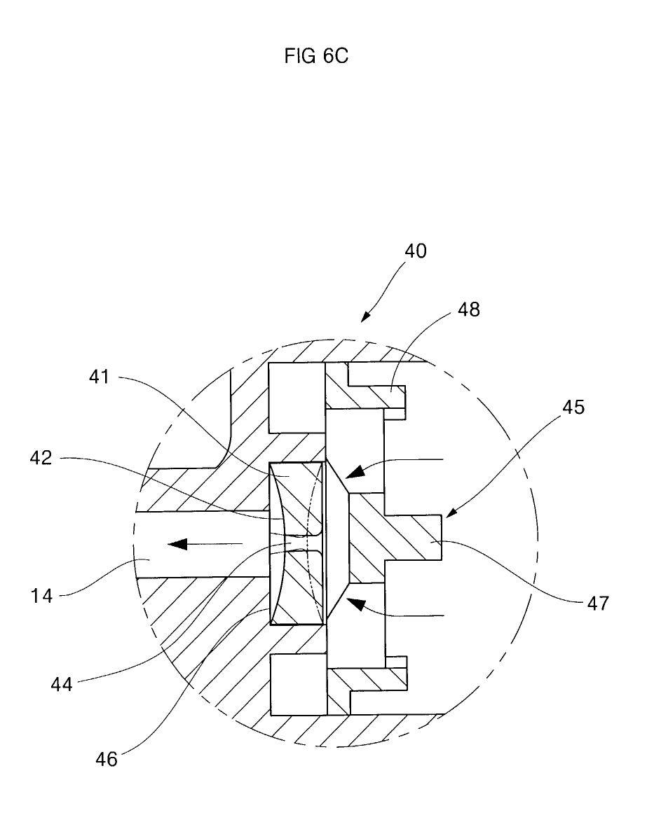

The pair of second valve assemblies 50 and 50a have the same structure. Specifically, referring to FIG. 4, the second valve assemblies 50 and 50a have an integral valve box 58. As will be described later in detail, the ports 17 and 19 operatively connect the valve box 58, the outlet conduits 14 and 14a and the pipe joint assembly 60 with one another (see FIG. 6B). The second valve assemblies 50 and 50a have their respective casings 55 and 55a. The casings 55 and 55a are provided with solenoids, cylindrical movable members 52 and 52a, and springs 53 and 53a. The second valve assemblies 50 and 50a have coils 54 and 54a for forming magnetic fields in response to application thereto of electric signals and thereby moving the movable members 52 and 52a. The coils 54 and 54a are surrounded by covers 57 and 57a, and O-rings 56 and 56a are provided for the purpose of sealing the second valve assemblies 50 and 50a.

Describing a relationship between the ports 17 and 19 and the second valve assemblies 50 and 50a with reference to FIGS. 4 and 6B, in FIG. 6B, there is shown a partially-sectioned perspective view in which each port 17 and 19 is partially sectioned to illustrate structures of each outlet conduit 14 and 14a extending from the reservoir 16 parallel to the inlet conduit 12, and the valve box 58. Each port 17 and 19 includes a valve body 58a which has generally a drum-shaped configuration and is opened at an upper end thereof, a valve seat 58b which has a bell-shaped configuration and is defined with an aperture 51 or 51a, and a cavity 59 which is defined between the valve body 58a and the valve seat 58b. One side of each port 17 and 19 is defined with an entrance passage 11 for receiving fluid from each outlet conduit 14 and 14a extending outward from the housing 10. Another side of each port 17 and 19 is defined with an exit passage 13 for discharging fluid from each port 17 and 19 into corresponding outlet conduit 14 and 14a. The exit passage 13 is communicated with the inside of the valve seat 58b.

Describing operations of the ports 17 and 19 and the second valve assemblies 50 and 50a again with reference to FIGS. 3 through 7, in this preferred embodiment, the second valve assemblies 50 and 50a include electromagnetic valves such that the second valve assemblies 50 and 50a can open and close the apertures 51 and 51a of the ports 17 and 19 in response to externally applied electric signals so as to control fluid flow. For example, an electric signal for opening the apertures 51 and 51a and allowing fluid flow through the apertures 51 and 51a are generated such that an ON signal is generated when the filter cartridge 1 is attached to the manifold M. In response to the ON signal, magnetic fields are produced in the coils 54 and 54a, and accordingly, the movable members 52 and 52a are moved upward while overcoming elastic force of the springs 53 and 53a.

By the upward movement of the movable members 52 and 52a constituting the solenoids, the apertures 51 and 51a are opened. Thus, the fluid, which flows from the reservoir 16 of the housing 10 through one parts of the outlet conduits 14 and 14a into the cavities 59 of the ports 17 and 19, is discharged through the apertures 51 and 51a into the other parts of the outlet conduits 14 and 14a communicated with the exit passages 13.

An OFF signal for closing the valves is generated, for example, when the filter cartridge 1 is decoupled from the manifold M. Therefore, as no electric signal is applied to the solenoids, magnetic fields are no longer generated in the coils 54 and 54a. Thus, due to the fact that the movable members 52 and 52a are pressed downward by the elastic force of the springs 53 and 53a, the valve heads 52h provided to the movable members 52 and 52a close the apertures 51 and 51a, whereby fluid flow from the ports 17 and 19 into the other parts of the outlet conduits 14 and 14a is interrupted. Also, when the filter cartridge 1 is decoupled from the manifold M, since fluid flow through the inlet conduit 12 is shut off by the first valve assembly 30, water leakage is prevented.

As described above, in the manifold M according to the present invention, the flow parts or passages for inflow and outflow of fluid are provided in the shape of conduits. For this reason, it is possible to secure a space such as the reservoir 16 in the housing 10 of the manifold M, and flow control means 40 can be provided to the secured space, that is, reservoir 16, as will be described later in detail. Further, because it is possible to install in the conduits 12, 14 and 14a the valve assemblies or means capable of controlling inflow and outflow of fluid, not only can valve assembly installing operations be easily executed, but also necessary measures can be taken even in the case of breakdown of the valve assemblies.

Moreover, the ports 17 and 19 can be formed in the courses of the inlet and outlet conduits 12, 14 and 14a, and the valve assemblies can be installed using these ports 17 and 19. Various mechanisms can be provided for forming chambers in the ports 17 and 19 and thereby controlling fluid flow. Therefore, by forming the ports 17 and 19 in the conduits 12, 14 and 14a and installing the valve assemblies in the ports 17 and 19, pipe jointing means or assemblies can be utilized to easily joint and disjoint conduits with and from one another.

In place of the first valve assembly 30 composed of a stem valve as described above, an electromagnetic valve such as constituting the second valve assemblies 50 and 50a can be installed in the inlet conduit 12. In this case, the manifold M according to the present invention can be applied to other types of filter cartridges which are different from the filter cartridge 1 having the double-staged flange structure.

Referring again to FIGS. 3 through 7, specifically, 6B and 6C, the flow control means 40 is provided in the reservoir 16 of the housing 10 to be associated with at least one of the outlet conduits 14 and 14a. The flow control means 40 has a disc-shaped flow control unit 41. The flow control unit 41 is made of a material having a predetermined flexibility in a manner such that the flow control unit 41 can be displaced by a pressure change of fluid discharged from the reservoir 16 of the housing 10 into the outlet conduit 14. In this preferred embodiment of the present invention, the flow control unit 41 is made of ethylene propylene diene methylene (EPDM) which has excellent heat resistance, ozone resistance, weather resistance, electrical characteristic, etc.

The flow control unit 41 has a gradually curved and sinking surface 42 which faces the outlet conduit 14, and a flat surface which is opposite to the gradually curved and sinking surface 42. A flow control hole 44 is defined through a center portion of the flow control unit 41. Also, the flow control means 40 has a wheel-shaped retainer 45. The wheel-shaped retainer 45 is composed of a hub 47, a rim 48 and a plurality of spokes which radially extend between the hub 47 and rim 48. A sealing element such as an O-ring is provided around a circumferential outer surface of the rim 48 of the retainer 45. The sealing element is press-fitted to be brought into surface contact with a circumferential inner surface of the housing 10, defining the reservoir 16.

A pair of depressions 46 are defined on an inner surface of one end of the reservoir 16 to which the outlet conduits 14 and 14a are connected, in a manner such that at least one of the depressions 46 is provided with the flow control unit 41.

When fluid does not flow from the reservoir 16 of the housing 10 into the outlet conduit 14, the flow control unit 41 is maintained in an initially installed state. That is to say, the gradually curved and sinking surface 42 facing the outlet conduit 14 is maintained in a curved and sinking state, and the opposite flat surface is maintained in a flattened state. On the other hand, if fluid starts to flow from the reservoir 16 of the housing 10 into the outlet conduit 14, as shown in FIGS. 6A and 6C by the arrows, fluid flows through the spokes of the retainer 45 and then passes through the flow control hole 44 of the flow control unit 41 to be discharged into the outlet conduit 14. At this time, as a fluid pressure is applied to the flat surface of the flow control unit 41 while fluid flows through the flow control hole 44, the gradually curved and sinking surface 42 of the flow control unit 41 made of a flexible material is moved forward to be flattened and then comes into surface contact with a bottom surface of the depression 46 which defines an entrance into the outlet conduit 14. On the other hand, as the flat surface opposite to the sinking surface 42 is gradually depressed, the flow control unit 41 experiences displacement.

The flow control hole 44 is influenced by the displacement in which the gradually curved and sinking surface 42 and opposite flat surface of the flow control unit 41 are reversed in their surface contours. Hence, by the fact that the sinking surface 42 is transformed from a curved surface to a flat surface by fluid flow through the flow control hole 44 into the outlet conduit 14, a diameter of one end of the flow control hole 44, which one end faces the outlet conduit 14, is slightly increased. On the contrary, a diameter of the other end of the flow control hole 44, which other end faces the retainer 45, is slightly decreased. As a result, the flow control hole 44 generally has a funnel-shaped configuration. In the case that fluid does not flow through water supply lines due to decoupling of the filter cartridge 1 from the manifold M, the flow control unit 41 is returned to its original state. In this way, fluid flow control can be executed by the flow control means 40 in the reservoir 16 of the housing 10 in correspondence to fluid flow and fluid flow interruption.

Of course, a degree to which a diameter of the flow control hole 44 of the flow control unit 41 is changed may be varied depending upon a size of an appliance employing the manifold M. In other words, in the case that a diameter of the outlet conduits 14 and 14a of the manifold M is large, a size of the flow control unit 41 and a diameter of the flow control hole 44 are increased, and vice versa. Accordingly, the flow control means 40 according to the present invention is able to control fluid flow in conformity with a situation.

In the manifold M according to the present invention, since inlet and outlet passages are defined in the shape of conduits, at any position, the conduits 12, 14 and 14a can be easily branched to extend toward desired places and can be easily jointed with other fluid supply pipes. That is to say, the pipe jointing assembly 60 capable of being easily jointed and disjointed can be used to connect the inlet conduit 12 with the water supply pipe 2 as shown in FIG. 1 and to branch and joint the outlet conduits 14 and 14a with other fluid supply pipes as shown in FIGS. 3, 4 and 6A through 6C.

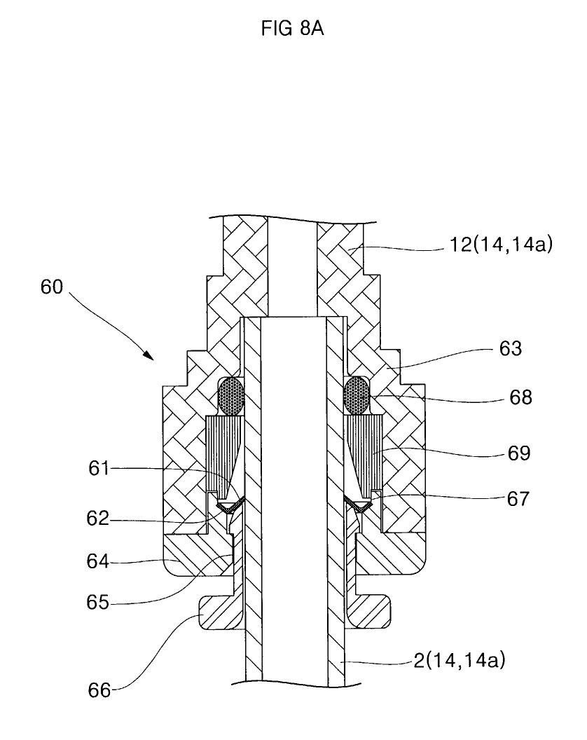

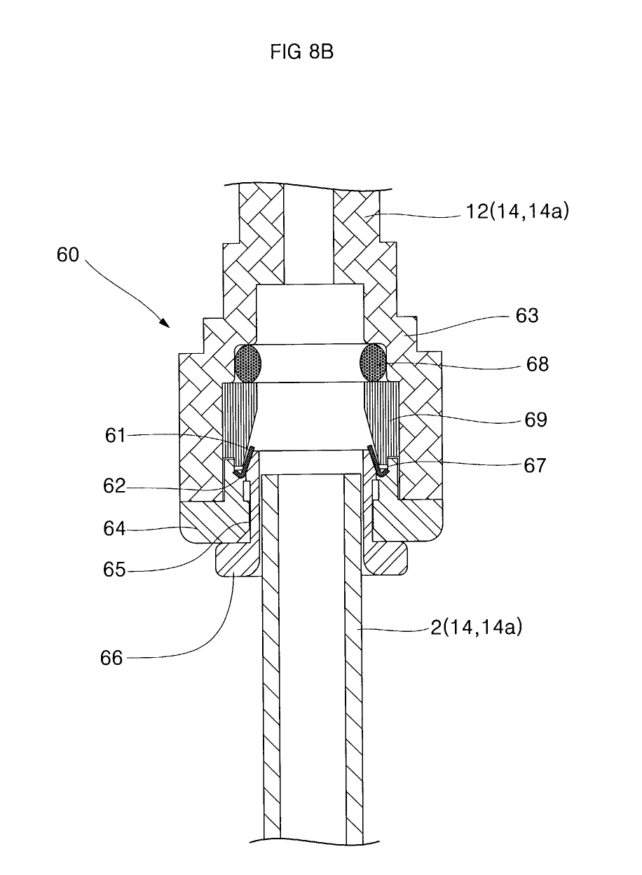

FIG. 8A illustrates a state wherein two pipes are connected with each other, and FIG. 8B illustrates another state wherein two pipes are disconnected from each other. Describing, for example, the case that the inlet conduit 12 and the water supply pipe 2 are connected with each other, a coupling end portion 63 of the inlet conduit 12 has a plurality of stepped surfaces on which various component elements are disposed. The pipe jointing assembly 60 includes a pipe fastening member 62. The pipe fastening member 62 has an annular frame portion and a plurality of elastic supporting fragments 61 integrally extending from the annular frame portion. Also, the pipe jointing assembly 60 is provided with a cylindrical fixing cap 64. The cylindrical fixing cap 64 has a head and a shoulder 67 for holding the pipe fastening member 62. The fixing cap 64 is defined with a center hole 65 through which the inlet conduit 12 can be inserted. The pipe jointing assembly 60 further includes an unlocking member 66 for allowing the inlet conduit 12 and the water supply pipe 2 to be decoupled from each other, and a holder 69 which has an inclined surface for keeping the pipe fastening member 62 from being released upon decoupling the inlet conduit 12 and the water supply pipe 2 from each other. Further, an O-ring 68 is provided to prevent water leakage.

When the inlet conduit 12 and the water supply pipe 2 are connected with each other, as shown in FIG. 8A, by pushing the water supply pipe 2 into the inlet conduit 12, the water supply pipe 2 is inserted into the inlet conduit 12 while overcoming force of the elastic supporting fragments 61 of the pipe fastening member 62 until a free end of the water supply pipe 2 is brought into contact with an innermost stepped surface which is formed in the coupling end portion 63 of the inlet conduit 12. Then, as the elastic supporting fragments 61 of the pipe fastening member 62 radially apply force to the water supply pipe 2, the water supply pipe 2 is reliably held coupled to the inlet conduit 12.

When the inlet conduit 12 and the water supply pipe 2 are disconnected from each other, as shown in FIG. 8B, by pushing the unlocking member 66 into the coupling end portion 63 of the inlet conduit 12, a free end of the unlocking member 66 separates the elastic supporting fragments 61 from the water supply pipe 2, whereby it is possible to easily decouple the water supply pipe 2 from the inlet conduit 12. At this time, due to the fact that the elastic supporting fragments 61 of the pipe fastening member 62 are stably held by the inclined surface of the holder 69, the pipe fastening member 62 is kept from being released from the shoulder 67 of the fixing cap 64.

In the drawings and specification, there have been disclosed typical preferred embodiments of the invention and, although specific terms are employed, they are used in a generic and descriptive sense only and not for purposes of limitation, the scope of the invention being set forth in the following claims.

What is claimed is:

1. A manifold adapted for supplying fluid to a fluid treatment device and discharging treated fluid to a desired place, the manifold comprising:
an inlet conduit for guiding fluid flow toward the fluid treatment device;
a housing defined with a flow bore and a reservoir which receives and stores fluid flowing from the fluid treatment device through the flow bore to accommodate a variation in fluid amount; and
at least one outlet conduit for discharging fluid stored in the reservoir of the housing;
wherein the inlet and outlet conduits are formed to extend outward from the housing, and the inlet conduit is attached to the housing in a manner such that fluid directly flows through the inlet conduit into the fluid treatment device while not passing through the housing.

2. The manifold as set forth in claim 1, wherein the outlet conduit is formed to extend in a direction which is the same as that in which the inlet conduit is attached to the housing.

3. The manifold as set forth in claim 1, wherein the outlet conduit is formed to extend in a direction which is different from that in which the inlet conduit is attached to the housing.

4. The manifold as set forth in claim 1, wherein the outlet conduit has a port for mounting valve means to control fluid flow from the reservoir and through the outlet conduit.

5. The manifold as set forth in claim 4, wherein the port comprises a valve body having a drum-shaped configuration and opened at one end thereof, a valve seat having a bell-shaped configuration and defined with an aperture, and a cavity defined between the valve body and the valve seat; a valve unit is arranged through opened one end of the valve body; one end of the outlet conduit extending from the housing is connected to the cavity to allow fluid flow thereinto; and a conduit is connected to the aperture of the valve seat to allow fluid to be discharged from the valve body.

6. The manifold as set forth in claim 4, wherein the valve means comprises an electromagnetic valve.

7. The manifold as set forth in claim 5, wherein the valve unit arranged through opened one end of the valve body comprises a solenoid, and a movable member of the solenoid has a valve head for controlling fluid flow in answer to energization and deenergization of the solenoid.

8. The manifold as set forth in claim 1, wherein the reservoir of the housing includes flow control means for controlling fluid flow in correspondence to a fluid pressure when fluid stored in the reservoir is discharged into the outlet conduit.

9. The manifold as set forth in claim 8, wherein the flow control means comprises a flow control unit having a predetermined flexibility to be deformed by a fluid pressure generated when fluid is discharged from the reservoir into the outlet conduit, and a wheel-shaped retainer for fixing the flow control unit inside the reservoir; the flow control unit has a gradually curved and sinking surface which faces the outlet conduit, a flat surface which is opposite to the sinking surface and a flow control hole which is defined through a center portion of the flow control unit; and, by the fluid pressure applied to the flow control valve when fluid is discharged from the reservoir into the outlet conduit, the sinking surface and the flat surface are deformed in a manner such that they are reversed in their surface contours and thereby fluid flow control is effected through the flow control hole.

10. The manifold as set forth in claim 9, wherein the flow control unit is made of ethylene propylene diene methylene (EPDM).
